(19) United States
(12) Patent Application Publication
(10) Pub. No.: US 2013/0188255 A1
(43) Pub. Date: Jul. 25, 2013

(54) METHOD OF PRODUCING HOLLOW MAGNESIUM FLUORIDE PARTICLES, AND ANTIREFLECTION COATING, OPTICAL DEVICE, AND IMAGING OPTICAL SYSTEM HAVING THE PARTICLES

(71) Applicants: Yu Kameno, Yokohama-shi (JP); Masanobu Ogane, Yokohama-shi (JP); Yoji Teramoto, Ebina-shi (JP)

(72) Inventors: Yu Kameno, Yokohama-shi (JP); Masanobu Ogane, Yokohama-shi (JP); Yoji Teramoto, Ebina-shi (JP)

(73) Assignee: CANON KABUSHIKI KAISHA, Tokyo (JP)

(21) Appl. No.: 13/877,446

(22) PCT Filed: Sep. 15, 2011
(86) PCT No.: PCT/JP2011/005218

§ 371 Date: Apr. 2, 2013

(30) Foreign Application Priority Data
Oct. 4, 2010 (JP) 2010-224952

(51) Int. Cl. G02B 1/11; C09D 5/00

(52) U.S. Cl. CPC G02B 1/11; C09D 5/006
USPC 359/601; 423/490; 428/357; 428/338

(57) ABSTRACT

The present invention provides a method of producing hollow magnesium fluoride particles by performing polymerization at the interface of micelle constituted of a hydrophobic solvent, a hydrophilic solvent, and a surfactant. The invention further provides an antireflection coating having a low refractive index due to the coating by the hollow magnesium fluoride particles and also provides an optical device coated with the antireflection coating and an imaging optical system having the optical device. In the method, micelle is formed from a hydrophobic solvent, a hydrophilic solvent, and a surfactant, and then a fluorine compound and a magnesium compound are dissolved in the micelle solution to polymerize magnesium fluoride at the interface of the micelle.

### TECHNICAL FIELD

The present invention relates to a method of producing hollow magnesium fluoride particles, i.e., magnesium fluoride particles containing air in the inside. The invention further relates to an antireflection coating obtained by application of a dispersion prepared by mixing the particles and a solvent and to an optical device obtained by forming the dispersion on a base material.

### BACKGROUND ART

It has been known that, in order to suppress reflection on the light incident/emitting surface of an optical device, desired optical characteristics are obtained by laminating an antireflection coating of a monolayer or multilayer of optical films having different refractive indices at a thickness of several tens to several hundreds nanometers. Such an antireflection coating is formed by a vacuum deposition process such as vapor deposition or sputtering or a wet film-formation process such as dip-coating or spin-coating.

As the material for the outermost layer of the antireflection coating, transparent materials having low refractive indices, for example, inorganic materials such as silica, magnesium fluoride, and calcium fluoride and organic materials such as silicon polymers, are known. Furthermore, PTLs 1 and 2 propose methods of forming an antireflection coating by application of a dispersion containing fine particles composed of an inorganic material such as silica or magnesium fluoride.

As a method for further reducing the refractive index of an antireflection coating, a technique using particles having a hollow structure (hereinafter referred to as hollow particles) is proposed. Since the hollow particles contain air, which has a refractive index of 1.0, inside thereof, an antireflection coating obtained by application of a dispersion of the particles can have a noticeably reduced refractive index. For example, NPL 1 proposes a method of producing hollow silica particles by forming water-in-oil micelle and then synthesizing silica on the interface of the micelle.

In order to further reduce the refractive index of the hollow particles, an increase in vacant space or use of a material having a lower refractive index (e.g., magnesium fluoride) as the shell component of the hollow particles having cavities is thought to be effective. However, the increase in vacant space reduces adhesion between the particles and between the particles and a base material for example and may, thereby, cause detachment of the particles from the base material.

In the case of reducing the refractive index by using a material having a lower refractive index, such as magnesium fluoride, as the shell component of hollow particles having cavities in the inside, it is necessary to produce hollow particles by a material having a low refractive index, such as magnesium fluoride, but a known technology such as that described in NPL 1 has a problem of difficulty in synthesizing magnesium fluoride on the interface of water and oil.

### CITATION LIST

### Patent Literature

PTL 1: Japanese Patent Laid-Open No. 61-118932

PTL 2: Japanese Patent Laid-Open No. 01-041149

### Non Patent Literature

NPL 1: Chemistry Letters, Vol. 34, No. 10 (2005)

### SUMMARY OF INVENTION

The present invention provides a method of producing hollow magnesium fluoride particles and provides an antireflection coating, an optical device, and an imaging optical system having the particles.

The method of producing hollow magnesium fluoride particles according to the present invention includes the step of mixing at least a hydrophobic solvent, a hydrophilic solvent, and an anionic surfactant to prepare a solution dispersing droplets of the hydrophilic solvent in the hydrophobic solvent or a solution dispersing droplets of the hydrophobic solvent in the hydrophilic solvent; the step of dissolving a fluorine compound and a magnesium compound in the solution; and step of drying the solution.

The antireflection coating of the present invention includes hollow magnesium fluoride particles produced by the method of producing hollow magnesium fluoride particles according to the present invention.

The optical device of the present invention includes the antireflection coating of the present invention formed on a base material.

The imaging optical system of the present invention forms an image of a subject by collecting light from the subject by the optical device of the present invention.

According to the present invention, hollow magnesium fluoride particles having cavities in the inside can be produced by means of micelle formation. An antireflection coating prepared from the hollow magnesium fluoride particles can be excellent in strength and have a low refractive index, compared to those prepared from magnesium fluoride fine particles.

Further features of the present invention will become apparent from the following description of exemplary embodiments with reference to the attached drawings.

### BRIEF DESCRIPTION OF DRAWINGS

FIG. 1 is a schematic diagram illustrating a hollow magnesium fluoride particle prepared by the present invention.

FIG. 2A is a schematic diagram illustrating a micelle interface to be used for synthesis of a hollow magnesium fluoride particle of the present invention.

FIG. 2B is a schematic diagram illustrating a micelle interface to be used for synthesis of a hollow magnesium fluoride particle of the present invention.

### DESCRIPTION OF EMBODIMENT

An embodiment of the present invention will be described with reference to the attached drawings.

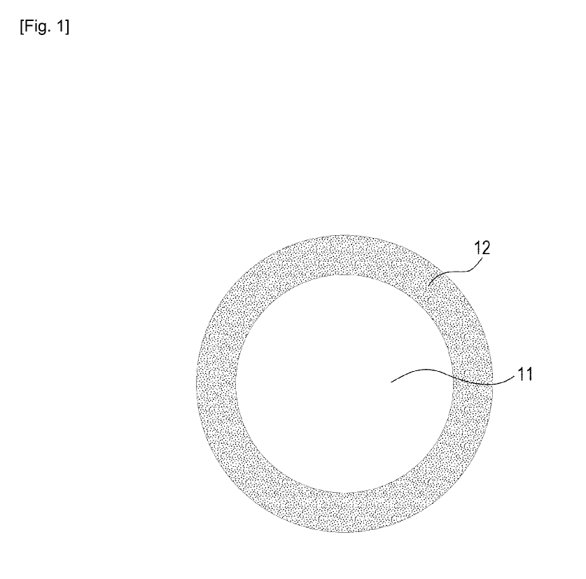

As shown in FIG. 1, the hollow magnesium fluoride particle produced by the present invention is constituted of a cavity 11 and magnesium fluoride 12 serving as a shell outside the cavity 11. The hollow magnesium fluoride particle can have a particle diameter of 10 nm or more and 200 nm or less. If the particle diameter is smaller than 10 nm, a nucleus rapidly grows in the synthesis of magnesium fluoride that forms a shell, which may cause formation of a particle not having a cavity. If the particle diameter is larger than 200 nm, visible light is scattered by the particle. Therefore, desired performance may not be obtained when an antireflection coating prepared by application of the particles is used as an optical device.

The volume of the cavity occupying the inside of a hollow magnesium fluoride particle of the present invention can be 22% or more and 73% or less. If the volume ratio is less than 22%, the effect of reducing the refractive index is low so that the refractive index of the particle is larger than 1.30. If the volume ratio is higher than 73%, the thickness of the magnesium fluoride shell 12 is smaller than 5% of the particle diameter, which may cause deformation of the particles during the coating process.

The method of producing hollow magnesium fluoride particles according the present invention includes the step of mixing a hydrophobic solvent, a hydrophilic solvent, and a surfactant to prepare a solution dispersing droplets of the hydrophilic solvent in the hydrophobic solvent or a solution dispersing droplets of the hydrophobic solvent in the hydrophilic solvent by means of micelle formation; and the step of synthesizing magnesium fluoride by adding a fluorine compound and a magnesium compound to the solution dispersing the droplets.

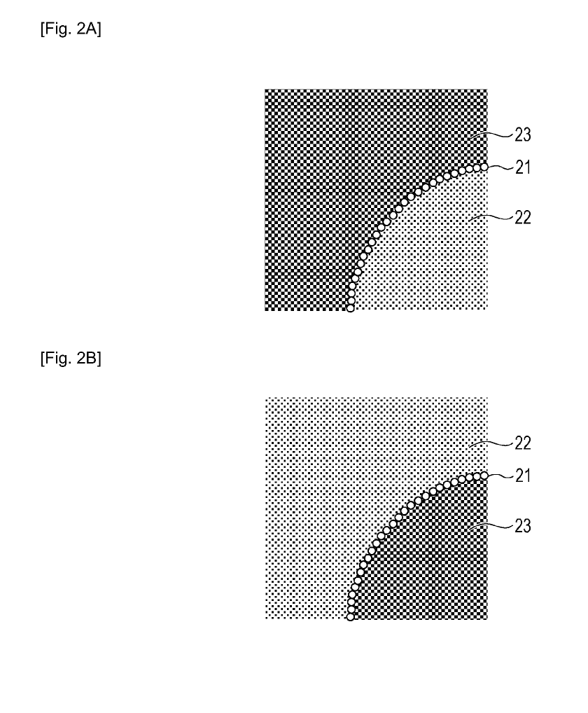

FIGS. 2A and 2B are each a schematic diagram illustrating an interface of a droplet in a solution obtained in the step of preparing a solution dispersing droplets. FIG. 2A shows an example of a droplet of a hydrophobic solvent 22 formed in a hydrophilic solvent 23 using surfactant molecules 21, the hydrophobic groups of which are oriented toward the hydrophobic solvent 22 and the hydrophilic groups of which are oriented toward the hydrophilic solvent 23. In contrast, FIG. 2B shows an example of a droplet of a hydrophilic solvent 23 formed in a hydrophobic solvent 22. The hydrophilic solvent can be water because of easiness to use. The hydrophobic solvent can be a non-polar solvent represented by a straight-chain alkane in order to improve the stability of the micelle. Hereinafter, the hydrophobic solvent is referred to as oil, and the hydrophilic solvent is referred to as water.

The surfactant can be appropriately selected depending on the type of micelle to be formed, that is, a surfactant suitable for forming oil-in-water micelle in which a droplet of a hydrophobic solvent 22 is formed in a hydrophilic solvent 23, a surfactant suitable for forming water-in-oil micelle in which a droplet of a hydrophilic solvent 23 is formed in a hydrophobic solvent 22, or a surfactant suitable for forming multilayer micelle that is a combination of the above. Examples of the surfactant for oil-in-water micelle include cetyl trimethyl ammonium bromide and sodium lauryl sulfate (SDS); and examples of the surfactant for water-in-oil micelle include quaternary ammonium salts and sodium di-2-ethylhexylsulfosuccinate (hereinafter referred to as AOT).

By using such micelle, the reaction field of compounds can be limited to the vicinity of the interface of micelle. This will now be described using a cationic compound A(+) and an anionic compound B(−) that show high solubility in oil, and a cationic compound C(+) and an anionic compound D(−) that show high solubility in water.

In the case of using A(+) and B(−) selected as compounds that react with each other using water as a catalyst, water-in-oil micelle is formed, and the compounds are added thereto. By doing so, a chain reaction of A(+) and B(−) is caused at the interface between the oil and the water droplet dispersed in the oil. As a result, a shell-like structure can be formed along the outer boundary of the droplet. In the case of using A(+) and D(−) selected as compounds that react with each other using water as a catalyst, a similar reaction is caused by dissolving D(−) in a water droplet of water-in-oil micelle in advance and adding A(+) thereto to form a shell-like structure along the outer boundary of the droplet, that is, a hollow particle. In the case of using B(−) and C(+) that react with each other using water as a catalyst and the case of using oil-in-water micelle by similarly selecting A(+), B(−), C(+), or D(−), hollow particles can be obtained. However, in the case of using C(+) and D(−) that react in water solvent, a reaction also occurs at sites other than the interface of micelle, which makes it difficult to obtain a shell structure.

In a reaction between a fluorine compound and a magnesium compound, since the surface of a magnesium fluoride product is positively charged, an anionic surfactant such as SDS or AOT can be used as the surfactant when the shell of a hollow magnesium fluoride particle is formed. If a cationic surfactant is used, the cationic surfactant and the positively charged magnesium fluoride repel each other, which makes it difficult to limit the reaction field to the vicinity of water/oil interface, resulting in difficulty of formation of the shell.

Furthermore, the fluorine compound and the magnesium compound serving as the raw materials of magnesium fluoride are appropriately selected depending on the micelle structure, i.e., oil-in-water or water-in-oil structure. In the case of dissolving a fluorine compound in an aqueous layer, the fluorine compound can be, for example, ammonium fluoride, potassium fluoride, sodium fluoride, or hydrofluoric acid. In the case of dissolving a fluorine compound in an oil layer, a nucleophilic fluorinated compound having low hygroscopicity and low solubility in an aqueous layer is used. Examples of such a compound include tetrabutylammonium difluorotriphenylsilicate (hereinafter referred to as TBAT) and tetrabutylammonium difluorotriphenylstannate. The nucleophilic fluorinated compound herein is a compound of which fluorine atom reacts with an atom having a low electron density to form a bond. In the case of dissolving a magnesium compound in an aqueous layer, the magnesium compound can be a magnesium salt such as magnesium chloride, magnesium nitrate, magnesium phosphate, magnesium sulfate, or magnesium carbonate. In the case of dissolving a magnesium compound in an oil layer, for example, a magnesium alkoxide can be used as the magnesium compound, but organic magnesium halides represented by a Grignard reagent are stable rather in a water-soluble solvent. If both a fluorine compound and a magnesium compound are dissolved in a hydrophilic solvent, the reaction field of a salt exchange reaction is not limited to the vicinity of the water/oil interface, resulting in no formation of a hollow shell. Accordingly, the fluorine compound and the magnesium compound can be selected so that at least one of them is dissolved in an oil layer. When the fluorine compound and the magnesium compound are hardly dissolved in an oil layer, it is possible to dissolve the compounds in an oil layer by using oil having low polarity. However, in this case, since the micelle size may be changed by the interaction between the oil having low polarity and water, in order to synthesize hollow magnesium fluoride particles having a small size, addition of an appropriate surfactant is necessary.

As described above, for example, hollow magnesium fluoride particles may be produced by forming water-in-oil micelle composed of isooctane, water, and AOT and then mixing TBAT and magnesium ethoxide sequentially with the micelle.

The method using micelle can produce hollow particles without using template particles and therefore can produce hollow particles not containing elements other than fluorine and magnesium.

An antireflection coating having a low refractive index can be obtained by collecting the resulting hollow magnesium fluoride particles and performing application of the particles. The hollow magnesium fluoride particles may be collected from the solution by any known technique. For example, the hollow magnesium fluoride particles may be collected from a solution by heating and drying the solution. By application of the collected hollow magnesium fluoride particles onto a base material, an antireflection coating including the hollow magnesium fluoride particles is produced. As the solvent for the application, for example, water, an organic solvent, or a fluorine-based solvent can be used. In the case of application using a volatile solvent such as water, the antireflection coating is composed of only the hollow magnesium fluoride particles, and the outside of the particles is air. Therefore, the refractive index of the coating can be noticeably reduced. If the ratio of the hollow particles in the antireflection coating is small, the strength of the coating is decreased. Accordingly, the ratio of the hollow particles occupying in the antireflection coating can be 50% or more. On this occasion, the refractive index can be reduced to the lowest, 1.05, by using hollow magnesium fluoride particles having a void content of 73%.

Furthermore, it is possible to use a solvent with a low refractive index in order to reinforce the strength while maintaining the performance of the antireflection coating. For example, an antireflection coating can be obtained by application of a dispersion prepared by dispersing hollow magnesium fluoride particles in a fluorine-based solvent having a low refractive index, such as Teflon AF 2400. However, in order to find superiority to an antireflection coating (refractive index: 1.38) produced by vacuum deposition of magnesium fluoride, the refractive index should be 1.36 or less.

Accordingly, the antireflection coating of the present invention has a refractive index of 1.05 or more and 1.36 or less.

As the method of application, solution application such as spin coating, bar coating, or dip coating is simple and low in cost and can be therefore used. Furthermore, the hollow magnesium fluoride particles produced by the method according to the present invention may be formed into a film by a method such as sputtering or vapor deposition to use as an antireflection coating.

By forming such an antireflection coating on a transparent base material such as plastic or glass, the reflectivity of the surface can be noticeably reduced to give an optical device showing highly excellent antireflection effect. A monolayer or multilayer film can be disposed between the base material and the antireflection coating of the present invention. The antireflection coating coated with the particles produced by the method for producing hollow magnesium fluoride particles of the present invention has a very low refractive index and, thereby, shows excellent antireflection performance and has high strength. Therefore, the antireflection coating can be formed as the outermost layer of the optical device.

The optical device provided with the antireflection coating of the present invention can be used for imaging optical system such as an imaging lens of, for example, a camera.

As long as at least one of optical devices of an imaging optical system is the optical device of the present invention, light from a subject is collected through this optical device to form an image of the subject on an image pickup device. At least one of antireflection coatings provided to an optical device is an antireflection coating coated with particles obtained by the method of producing hollow magnesium fluoride particles of the present invention. The antireflection coating coated with particles obtained by the method of the present invention has a very low refractive index and, thereby, shows excellent antireflection performance and has high strength. Therefore, the antireflection coating can be disposed on the outermost side in the optical devices of an imaging optical system.

The optical device can be also applied to, for example, binocular telescopes, displays such as a projector, and window glass.

### Examples

Examples of the present invention will be described below, but the present invention is not limited to only the scope of the examples.

### Example 1

An oil-in-water micelle solution dispersing water particles (droplets) of 47 nm was produced by stirring 100 g of isooctane, 10 g of AOT, and 30 g of water for 1 hr.

To the resulting solution, 10 g of a solution of 5 wt % of TBAT in phenyl methyl ether was added to dissolve the TBAT in the oil layer, followed by mixing with 20 g of a solution of 1 wt % of magnesium ethoxide in phenyl methyl ether with stirring at 60 degrees Celsius for 1 hr. to synthesize magnesium fluoride.

To the solution containing the synthesized magnesium fluoride, 40 mL of ethanol was added to separate the hydrophilic solvent from the hydrophobic solvent. The hydrophilic solvent was dried and then subjected to observation with a scanning transmission electron microscope (manufactured by Hitachi High-Technologies Corp., HD-2700) to confirm hollow particles having a particle diameter of 500 nm.

### Example 2

A solution of water-in-oil micelle was produced in the same manner as in EXAMPLE 1.

To the resulting solution, 10 g of a solution of 5 wt % of TBAT in phenyl methyl ether and 5 g of AOT were added to dissolve the TBAT in the oil layer, followed by mixing with 20 g of a solution of 1 wt % of magnesium ethoxide in phenyl methyl ether and 5 g of AOT with stirring at 60 degrees Celsius for 1 hr. to synthesize magnesium fluoride.

To the solution containing the synthesized magnesium fluoride, 40 mL of ethanol was added to separate the hydrophilic solvent from the hydrophobic solvent. The hydrophilic solvent was dried and then observed with a scanning transmission electron microscope to confirm hollow particles having a particle diameter of 200 nm The diameter of the cavity was 60% of the particle diameter, and therefore the void content was 22%.

### Example 3

A solution of water-in-oil micelle was produced in the same manner as in EXAMPLE 1.

To the resulting solution, 9 g of a solution of 5 wt % of TBAT in phenyl methyl ether and 5 g of AOT were added to dissolve the TBAT in the oil layer, followed by mixing with 9 g of a solution of 1 wt % of magnesium ethoxide in phenyl methyl ether and 5 g of AOT with stirring at 60 degrees Celsius for 1 hr. to synthesize magnesium fluoride.

To the solution containing the synthesized magnesium fluoride, 40 mL of ethanol was added to separate the hydrophilic solvent from the hydrophobic solvent. The hydrophilic solvent was dried and then subjected to observation with a scanning transmission electron microscope to confirm hollow particles having a particle diameter of 200 nm. The diameter of the cavity was 90% of the particle diameter, and therefore the void content was 73%.

### Example 4

A water-in-oil micelle solution dispersing water particles (droplets) of 9 nm was produced by stirring 100 g of isooctane, 10 g of AOT, and 7 g of water for 1 hr.

To the resulting solution, 3 g of a solution of 5 wt % of TBAT in phenyl methyl ether and 1 g of AOT were added to dissolve the TBAT in the oil layer, followed by mixing with 3 g of a solution of 1 wt % of magnesium ethoxide in phenyl methyl ether and 1 g of AOT with stirring at 60 degrees Celsius for 1 hr. to synthesize magnesium fluoride.

To the solution containing the synthesized magnesium fluoride, 40 mL of ethanol was added to separate the hydrophilic solvent from the hydrophobic solvent. The hydrophilic solvent was dried and then subjected to observation with a scanning transmission electron microscope to confirm hollow particles having a particle diameter of 10 nm The diameter of the cavity was 70% of the particle diameter, and therefore the void content was 34%.

### Example 5

The hollow particles obtained in EXAMPLE 4 were dispersed in 10 mL of Teflon AF 2400. The resulting dispersion was applied onto a silicon wafer by spin coating to form an antireflection coating having a thickness of 120 nm. The refractive index of this antireflection coating was 1.27.

### Example 6

In this example, as in EXAMPLE 5, a dispersion in which hollow magnesium fluoride particles were dispersed in Teflon AF 2400 was prepared, and the dispersion was applied onto BK7 glass having a refractive index of 1.52 (at a wavelength of 589 nm) by spin coating to form an antireflection coating having a thickness of 120 nm The refractive index of this antireflection coating was 1.26. The reflectivity was measured with a spectrophotometer (manufactured by Hitachi High-Technologies Corp., U-4000). The results are shown in Table 1. The reflectivity in visible light wavelength region was 2% or less in the whole area, and therefore the antireflection coating was applicable to optical devices.

TABLE 1

Wavelength (nm)

| | 400 | 500 | 600 | 700 |
|---|---|---|---|---|
| Reflectivity (%) | 1.83 | 0.33 | 0.03 | 0.15 |

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2010-224952, filed Oct. 4, 2010, which is hereby incorporated by reference herein in its entirety.

### INDUSTRIAL APPLICABILITY

The present invention is suitably applicable to devices in which light reflected at the interface with air is unnecessary, such as optical devices that are mounted on image pickup equipment represented by cameras and video cameras and image projection equipment represented by liquid crystal projectors and optical scanning units of electrophotographic apparatuses.

1. A method of producing hollow magnesium fluoride particles comprising:
mixing at least a hydrophobic solvent, a hydrophilic solvent, and an anionic surfactant to prepare a solution dispersing droplets of the hydrophilic solvent in the hydrophobic solvent or a solution dispersing droplets of the hydrophobic solvent in the hydrophilic solvent;
dissolving a fluorine compound and a magnesium compound in the solution; and
drying the solution.

2. The method of producing hollow magnesium fluoride particles according to claim 1, wherein the fluorine compound is a nucleophilic fluorinated compound.

3. An antireflection coating comprising hollow magnesium fluoride particles produced by a method of producing hollow magnesium fluoride particles according to claim 1.

4. The antireflection coating according to claim 3, wherein the hollow magnesium fluoride particles have a particle diameter of 10 nm or more and 200 nm or less.

5. The antireflection coating according to claim 3, wherein the ratio of the cavity volume to the hollow magnesium fluoride particle volume is 22% or more and 73% or less.

6. The antireflection coating according to claims 3, wherein the antireflection coating has a refractive index of 1.05 or more and 1.36 or less.

7. An optical device comprising a base material and an antireflection coating according to claim 3 disposed on the base material.

8. An imaging optical system forming an image of a subject by collecting light from the subject by an optical device according to claim 7.
